(19) United States
(12) Patent Application Publication
(10) Pub. No.: US 2026/0136089 A1
(43) Pub. Date: May 14, 2026

(54) IMAGE COLLECTION METHODS AND IMAGE CAPTURE DEVICES

(71) Applicant: Industrial Technology Research Institute, Hsinchu (TW)

(72) Inventors: Yi-Ning Huang, Chiayi County (TW); Yin-Cheng Lin, Taoyuan City (TW); Shin-Yi Wu, Taoyuan City (TW); Tan-Chi Ho, New Taipei City (TW)

(73) Assignee: Industrial Technology Research Institute, Hsinchu (TW)

(21) Appl. No.: 18/977,980

(22) Filed: Dec. 12, 2024

(30) Foreign Application Priority Data
Nov. 14, 2024 (TW) 113143708

(51) Int. Cl. H04N 23/60; G06T 19/00; H04N 23/63

(52) U.S. Cl. CPC H04N 23/64; G06T 19/006; H04N 23/635

(57) ABSTRACT

An image collection method and an image capturing device. The method comprises: obtaining first coverage density data of one or more first images based on captured first images of a target object to determine one or more re-shooting positions; rendering one or more shooting position suggestion marks corresponding to the one or more re-shooting positions in an image corresponding to a real space displayed in real-time by the image capturing device; and when a current position and a current viewing angle of the image capturing device match a target shooting position suggestion mark, automatically capturing a target second image corresponding to the target shooting position suggestion mark toward the target object. Thereby, the present disclosure provides a method that can effectively guide users to complete image collection required for 3D object modeling.

### CROSS-REFERENCE TO RELATED APPLICATION

This application claims the priority benefit of Taiwan application serial no. 113143708, filed on Nov. 14, 2024. The entirety of the above-mentioned patent application is hereby incorporated by reference herein and made a part of this specification.

### BACKGROUND

### Technical Field

The present disclosure relates to a 3D object modeling method, and more particularly to an image collection method for 3D object modeling and a corresponding image capturing device.

### Description of Related Art

With the development of 3D modeling technology, more and more application scenarios require converting physical objects into 3D models. Traditional 3D scanning equipment is expensive and has many usage limitations, therefore multi-view image-based 3D reconstruction technology has gradually become popular. However, existing image collection methods mainly rely on users' shooting experience, making it difficult to ensure that the collected image data can uniformly cover all viewing angles of the object. Furthermore, existing technology lacks a real-time evaluation mechanism for collected images, resulting in users being unable to know the completeness of the data during the shooting process, often requiring multiple repeated shoots to obtain ideal modeling results. Although some existing solutions provide basic shooting guidance functions, such as using grid maps or shooting trajectories to determine whether the entire object has been circled, these methods often cannot dynamically update suggestions based on actual shooting conditions, and also lack an evaluation mechanism for image quality.

### SUMMARY

The present disclosure provides an image collection method and a corresponding image capturing device. The present disclosure calculates coverage density data of images, evaluates the completeness of collected images, and provides shooting suggestions based on evaluation results. Combined with augmented reality (AR) technology for visual guidance, it assists users in completing the image collection required for 3D object modeling. The present disclosure provides automatic shooting functionality, capturing images when users move to designated positions, thereby improving the efficiency of image collection.

One or more embodiments of the present disclosure provide an image collection method adapted for constructing to a 3D object model corresponding to a target object by an electronic device. The method includes: based on captured one or more first images of the target object, obtaining first coverage density data of each of the one or more first images; determining one or more re-shooting positions based on the first coverage density data of each of the one or more first images; rendering one or more shooting position suggestion marks corresponding to the one or more re-shooting positions in an image corresponding to a real space displayed in real-time by the electronic device; for a target shooting position suggestion mark among the one or more shooting position suggestion marks, in response to determining that a current position and a current viewing angle of the electronic device match the target shooting position suggestion mark, automatically capturing a target second image corresponding to the target shooting position suggestion mark toward the target object.

In one or more embodiments of the present disclosure, after capturing one or more second images corresponding to the one or more shooting position suggestion marks, the method further includes: obtaining second coverage density data of each of the one or more second images; obtaining a coverage density average value corresponding to the target object based on the first coverage density data of each of the first images and the second coverage density data of the one or more second images; and when the coverage density average value is greater than or equal to a preset average density threshold value, determining that image data for constructing the 3D object model has been collected completely, and using the captured one or more first images and the one or more second images to execute a 3D object reconstruction operation corresponding to the target object, so as to construct the 3D object model corresponding to the target object.

In one or more embodiments of the present disclosure, when the coverage density average value is less than the preset average density threshold value, the method further includes: determining that the image data for constructing the 3D object model has not been collected completely; determining one or more other re-shooting positions based on the first coverage density data of the first images and the second coverage density data of the one or more second images; rendering one or more other shooting position suggestion marks corresponding to the one or more other re-shooting positions in the image corresponding to the real space displayed in real-time by the electronic device; and for a target other shooting position suggestion mark among the one or more other shooting position suggestion marks, in response to determining that the current position and the current viewing angle of the electronic device match the target other shooting position suggestion mark, automatically capturing a target third image corresponding to the target other shooting position suggestion mark toward the target object.

In one or more embodiments of the present disclosure, before capturing the first image or the second image, the method further includes: obtaining a reference plane and a boundary box of the target object to establish a 3D coordinate system and a 3D shooting range corresponding to the target object in the real space.

In one or more embodiments of the present disclosure, each shooting position suggestion mark comprises suggested 3D coordinates corresponding to the 3D coordinate system and the 3D shooting region and a suggested second viewing angle corresponding to the suggested 3D coordinates, the method further includes: determining whether current 3D coordinates of the current position of the electronic device correspond to a target suggested 3D coordinate among the one or more suggested 3D coordinates, and determining whether the current viewing angle of the electronic device corresponds to a target suggested second viewing angle of the target suggested 3D coordinate; when the current 3D coordinates correspond to the target suggested 3D coordinate and the current viewing angle corresponds to the target suggested second viewing angle, determining that the current position and the current viewing angle of the electronic device match the corresponding target shooting position suggestion mark, and automatically executing an image capture operation toward the target object to capture the target second image corresponding to the target shooting position suggestion mark.

In one or more embodiments of the present disclosure, the 3D shooting region comprises a plurality of pixel 3D coordinates, the method further includes: identifying a capturing position and a first viewing angle of each first image, wherein the capturing position comprises first 3D coordinates in the 3D coordinate system where the electronic device is located when capturing each first image; and obtaining the first coverage density data corresponding to the target object of each first image based on a coverage density distribution model, wherein the first coverage density data comprises a plurality of first coverage density values of a plurality of first pixels corresponding to the first image and a plurality of first pixel 3D coordinates of the first pixels mapped to the pixel 3D coordinates, wherein the first pixel 3D coordinates are determined by the capturing position and the first viewing angle corresponding to the first image.

In one or more embodiments of the present disclosure, obtaining the first coverage density data corresponding to the target object of each first image based on the coverage density distribution model includes: identifying a center pixel among the first pixels of each first image; identifying a plurality of target pixels corresponding to the target object among the first pixels of each first image; obtaining a reference distance between each target pixel and the center pixel; looking up a first coverage density value of each target pixel based on the reference distance of each target pixel and the coverage density distribution model, wherein the coverage density distribution model is dynamically set according to shooting field of view parameters of the electronic device and a relative distance between the capturing position and the target object.

In one or more embodiments of the present disclosure, the method further includes: projecting the pixel 3D coordinates of the 3D shooting region onto a 2D plane to generate a corresponding 2D mapping diagram, wherein the 2D mapping diagram comprises a plurality of pixel 2D coordinates corresponding to the pixel 3D coordinates; updating the 2D mapping diagram based on the first coverage density data corresponding to the target object of each first image, wherein each pixel 2D coordinate records a maximum first coverage density value of the corresponding pixel 3D coordinates.

In one or more embodiments of the present disclosure, determining the one or more re-shooting positions based on the first coverage density data of each of the one or more first images includes: obtaining a coverage density average value corresponding to the target object based on the first coverage density data of each of the first images; when the coverage density average value is less than a preset average density threshold value, identifying one or more low density pixel 3D coordinates with first coverage density values below a preset density threshold value based on the 2D mapping diagram; and determining the one or more re-shooting positions based on the one or more low density pixel 3D coordinates and corresponding one or more viewing angles.

In one or more embodiments of the present disclosure, determining the one or more re-shooting positions based on the one or more low density pixel 3D coordinates and the corresponding one or more viewing angles includes: identifying a target low density pixel 3D coordinate having a lowest first coverage density value among the one or more low density pixel 3D coordinates; determining a corresponding target re-shooting position based on the target low density pixel 3D coordinate; estimating an expected first image corresponding to the target re-shooting position and expected first coverage density data corresponding to the expected first image; updating the 2D mapping diagram based on the expected first coverage density data, and re-identifying new one or more low density pixel 3D coordinates with first coverage density values below the preset density threshold value; and repeating the above steps until no low density pixel 3D coordinates with values below the preset density threshold value exist among the pixel 3D coordinates.

In one or more embodiments of the present disclosure, the method further includes: recording the plurality of first coverage density values in each first coverage density data at corresponding pixel 3D coordinates; identifying one or more low density pixel 3D coordinates with first coverage density values below a preset density threshold value based on the first coverage density values recorded at each pixel 3D coordinate; and determining the one or more re-shooting positions based on the one or more low density pixel 3D coordinates and corresponding one or more viewing angles.

In one or more embodiments of the present disclosure, the method further includes: using augmented reality (AR) technology to render the one or more shooting position suggestion marks corresponding to the one or more re-shooting positions in the image corresponding to the real space displayed in real-time by the electronic device, such that the one or more shooting position suggestion marks are visually embedded and fixed in the real space in the image.

One or more embodiments of the present disclosure provide an image capturing device for constructing a 3D object model corresponding to a target object. The image capturing device includes: a processor; a storage device coupled to the processor for storing a plurality of program code modules; a camera module coupled to the processor; and a display coupled to the processor, wherein the processor is configured through execution of the stored program code modules to: obtain first coverage density data of one or more first images based on captured first images of the target object; determine one or more re-shooting positions based on the first coverage density data of the one or more first images; render one or more shooting position suggestion marks corresponding to the one or more re-shooting positions in an image corresponding to a real space displayed in real-time by the display; for a target shooting position suggestion mark among the one or more shooting position suggestion marks, in response to determining that a current position and a current viewing angle of the image capturing device match the target shooting position suggestion mark, control the camera module to automatically capture a target second image corresponding to the target shooting position suggestion mark toward the target object.

Based on the above, the image collection method and image capturing device provided by the present disclosure determine the coverage degree of captured images for the target object through coverage density data calculation and corresponding evaluation mechanisms, and dynamically determine re-shooting positions. The present disclosure uses augmented reality technology to render shooting position suggestion marks in the image displayed in real-time by the electronic device (also called 3D object modeling interface), facilitating guidance of the image capturing device to appropriate shooting positions. The present disclosure further provides automatic image capture functionality, determining whether the current position and angle match the shooting position suggestion mark when the image capturing device moves to the designated position, and if matched, automatically capturing the image. The present disclosure ensures the completeness of image collection through setting of coverage density average values and density threshold values, and provides shooting suggestions that conform to actual environmental conditions while considering the placement environment of the target object.

To make the aforementioned more comprehensible, several embodiments accompanied with drawings are described in detail as follows.

### BRIEF DESCRIPTION OF THE DRAWINGS

The accompanying drawings are included to provide a further understanding of the disclosure, and are incorporated in and constitute a part of this specification. The drawings illustrate exemplary embodiments of the disclosure and, together with the description, serve to explain the principles of the disclosure.

FIG. 1A is a block diagram of an image capturing device according to an embodiment of the present disclosure.

FIG. 1B is a schematic diagram showing shooting position suggestion marks and captured images displayed on a screen of the image capturing device according to an embodiment of the present disclosure.

FIG. 2 is a flow chart of an image collection method according to an embodiment of the present disclosure.

FIG. 3 is a flow chart of an image collection method according to another embodiment of the present disclosure.

FIG. 4A is a schematic diagram showing the establishment of a 3D coordinate system and 3D shooting range corresponding to a target object in real space according to an embodiment of the present disclosure.

FIG. 4B is a schematic diagram showing a distribution curve of coverage density values corresponding to capturing image points according to an embodiment of the present disclosure.

FIG. 5 is a schematic diagram showing the generation of a corresponding 2D mapping diagram based on multiple captured images according to an embodiment of the present disclosure.

FIG. 6 is a schematic diagram showing the determination of one or more re-shooting positions based on the 2D mapping diagram according to an embodiment of the present disclosure.

FIGS. 7A and 7B are schematic diagrams showing shooting position suggestion marks corresponding to re-shooting positions rendered in real-time displayed images corresponding to real space according to an embodiment of the present disclosure.

### DESCRIPTION OF THE EMBODIMENTS

Now detailed reference will be made to preferred embodiments of the present disclosure, examples of which are shown in the accompanying drawings. Whenever possible, the same reference numbers will be used throughout the drawings to refer to the same or similar components.

It should be understood that the terms “system” and “network” are often used interchangeably in the present disclosure. The term “and/or” in the present disclosure is used only to describe the association relationship between associated objects, which means there may exist four relationships. For example, A and/or B may mean four situations: A, B, A and B, A or B. Additionally, the character “/” in the present disclosure generally indicates that the associated objects are in an “or” relationship.

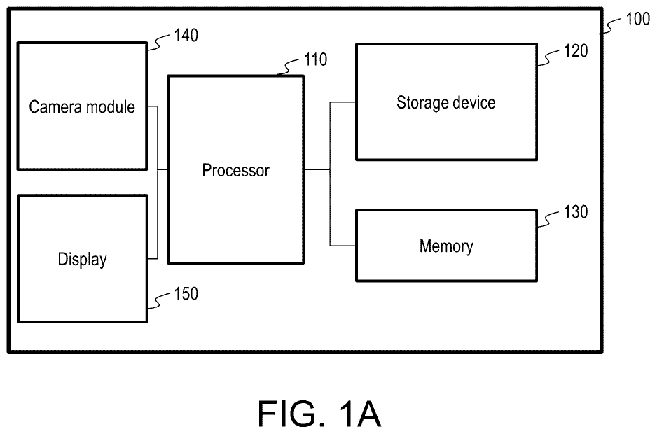

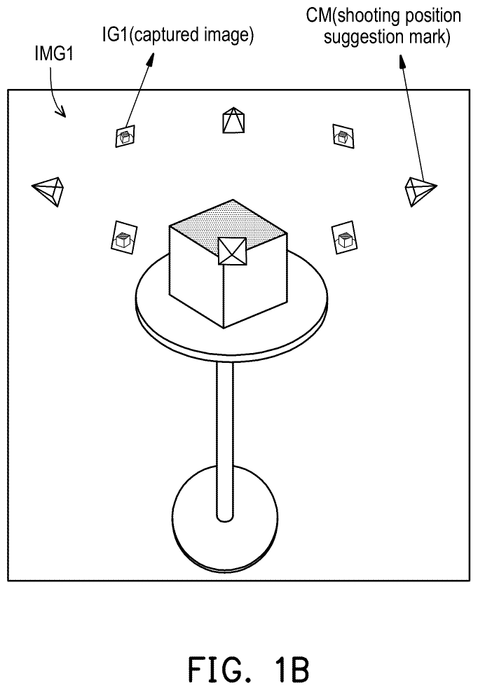

FIG. 1A is a block diagram of an image capturing device according to an embodiment of the present disclosure.

In one embodiment, the image capturing device 100 includes a processor 110, a storage device 120, a memory 130, a camera module 140, and a display 150. The processor 110 is electrically connected to the storage device 120, the memory 130, the camera module 140, and the display 150 respectively.

The image capturing device 100 can be a smart phone, a smart portable device, a head-mounted display, a tablet computer, a digital camera, or other portable electronic device with image capturing functionality. In some embodiments, the image capturing device 100 may also include other sensors, such as an Inertial Measurement Unit (IMU), for assisting in determining the position and pose of the image capturing device 100. In one embodiment, the image capturing device 100 can also be a drone, which can automatically move to the suggested re-shooting positions to capture corresponding images.

In this embodiment, the processor 110, based on program code modules stored in the storage device 120, controls the camera module 140 to capture images of the target object, and displays in real-time through the display 150 the images captured by the camera module 140 and shooting position suggestion marks. The processor 110 calculates coverage density data of captured images, determines re-shooting positions, and renders corresponding shooting position suggestion marks in the image displayed by the display 150. Furthermore, the processor 110 determines whether the current position and current viewing angle of the image capturing device 100 match the target shooting position suggestion mark, and if matched, controls the camera module 140 to automatically capture images. For example, in one embodiment, when the image capturing device 100 enters within a preset range of the shooting position suggestion mark (e.g., within the pyramid) and the camera viewing angle has a difference less than a preset angle (e.g., 10 degrees) from the suggested direction, the processor 110 automatically triggers image capture.

The memory 130 is used for temporarily storing computational data needed by the processor 110 when executing program code modules, such as coverage density data, shooting position information, etc. The storage device 120 is used for storing program code modules, captured image data, 3D object models, and other larger amounts of data. The display 150, in addition to displaying real-time images captured by the camera module 140, is also used for displaying visualization information such as shooting position suggestion marks. The camera module 140 is used for capturing images of the target object and transmitting image data to the processor 110 for processing.

In one embodiment, to implement position and viewing angle determination of the image capturing device 100 and augmented reality (AR) functionality, the image capturing device 100 may include the following sensors: (1) Inertial Measurement Unit (IMU), for example including one or more of the following: Accelerometer: measuring linear acceleration of the image capturing device 100, used for determining position changes; Gyroscope: measuring angular velocity of the image capturing device 100, used for determining rotational angle changes. (2) Optical sensing elements, for example including one or more of the following: Depth Camera: can measure the distance between the image capturing device 100 and the target object; IR Sensor: assisting in measuring spatial depth information; Stereo Camera: obtaining depth information through dual lenses.

In specific implementation scenarios, the data from these sensors can be integrated and utilized in the following ways:
(1) Spatial position tracking, for example including one or more of the following steps: IMU provides real-time motion information of the image capturing device 100; depth camera or stereo camera provides 3D spatial information of the environment; GPS or indoor positioning system provides absolute position reference.
(2) View angle determination, for example including one or more of the following steps: gyroscope and magnetometer determine the tilt angle and direction of the image capturing device 100; identifying relative position of the target object in the image through image processing technology; evaluating whether the shooting distance is appropriate by combining depth information.
(3) AR image overlay, for example including one or more of the following steps: using IMU data for dynamic image stabilization; correctly placing virtual objects through depth information; updating AR mark display positions based on position and pose information.
(4) Automatic shooting trigger, for example triggering automatic shooting functionality after one or more of the following conditions are satisfied: when all sensor data shows the image capturing device 100 has reached the suggested position; device pose matches the suggested viewing angle; distance to the target object is within an appropriate range; image stability meets requirements.

The data from these sensors can be integrated through Sensor Fusion technology to provide more accurate position and pose estimation. The processor 110 can determine in real-time whether the image capturing device 100 has reached suitable shooting conditions based on this comprehensive information, and correspondingly control the camera module 140 to perform automatic shooting.

On the other hand, in specific implementation scenarios, the processor 110 can be a Central Processing Unit (CPU), Graphics Processing Unit (GPU), Digital Signal Processor (DSP), Application-Specific Integrated Circuit (ASIC), Field-Programmable Gate Array (FPGA), or other computing unit suitable for executing the methods of the present disclosure. The processor 110 is responsible for executing program instructions stored in the storage device 120 or memory 130 to implement the image collection method of the present disclosure.

The storage device 120 can be Flash Memory, Solid State Drive (SSD), Hard Disk Drive (HDD), or other non-volatile storage media. The storage device 120 is used for storing various data or parameters for implementing this method, and program code modules and other data needed to implement the method of the present disclosure. Additionally, the storage device 120 can also store operating systems and applications (such as 3D modeling applications) and other software.

The memory 130 can be Random Access Memory (RAM), Dynamic Random Access Memory (DRAM), or other volatile memory.

The camera module 140 can include one or more image sensors, such as Complementary Metal-Oxide-Semiconductor (CMOS) sensors or Charge-Coupled Device (CCD) sensors, and related optical components such as lens assemblies and apertures. The display 150 can be a Liquid Crystal Display (LCD), Organic Light-Emitting Diode Display (OLED), or other suitable display device.

FIG. 1B is a schematic diagram showing shooting position suggestion marks and captured images displayed on a screen of the image capturing device according to an embodiment of the present disclosure.

In one embodiment, FIG. 1B shows an image IMG1 presented by the display 150 of the image capturing device 100. In this image IMG1, the processor 110 simultaneously displays captured images IG1 and shooting position suggestion marks CM.

Specifically, the cube in the middle is, for example, the target object. The captured images IG1 are thumbnails presented based on the captured first images of the target object. These thumbnails IG1 are distributed at different positions around the target object in image IMG1, with their positions corresponding to actual capturing positions, thereby providing users with intuitive spatial reference. Each captured image IG1 is presented on the display 150's screen with a corresponding tilt angle according to the shooting angle at the time. Users can also see what the captured pictures look like.

The processor 110 calculates and determines multiple re-shooting positions based on the first coverage density data of each of these captured images IG1. These re-shooting positions are presented in image IMG1 in the form of shooting position suggestion marks CM. Each shooting position suggestion mark CM appears as a quadrangular pyramid shape, with its plane relative to the vertex pointing toward the suggested shooting direction, and the vertex can be imagined as the source of the suggested shooting viewpoint. As can be seen, these shooting position suggestion marks CM are distributed in areas of image IMG1 where there are no captured images IG1, indicating that these positions need re-shooting to increase coverage density.

By simultaneously displaying captured images IG1 and shooting position suggestion marks CM in the same image IMG1, users can clearly understand the completed shooting positions and suggested re-shooting positions, helping to complete comprehensive image collection work. This visualization method allows users to intuitively understand shooting progress, improving operational convenience.

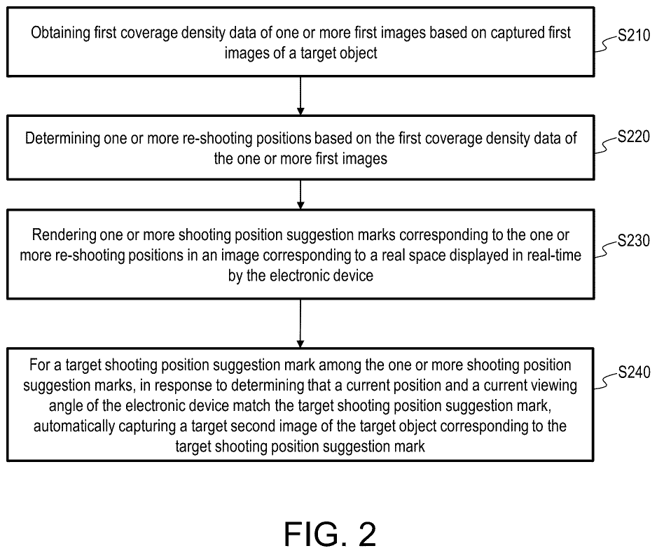

FIG. 2 is a flow chart of an image collection method according to an embodiment of the present disclosure. Please refer to FIG. 2, in one embodiment, the image collection method of the present disclosure includes steps S210 to S240.

In step S210, based on captured first images of the target object, obtain first coverage density data of each of the first images. Specifically, the processor 110 can identify the capturing position and first viewing angle of each first image, wherein the capturing position includes the first 3D coordinates where the image capturing device 100 is located in the 3D coordinate system when capturing each first image. Next, the processor 110 calculates the first coverage density data corresponding to the target object for each first image based on a coverage density distribution model, wherein the first coverage density data includes multiple first coverage density values of multiple first pixels corresponding to the first image, and multiple first pixel 3D coordinates of those first pixels mapped to pixel 3D coordinates.

More specifically, in one embodiment, before starting to capture images, the processor 110 first establishes a spatial reference system for the shooting environment. Specifically, the processor 110, with the assistance of the camera module 140 and other sensors, detects the reference plane (such as desktop or wall) where the target object is located, and adjusts the position and size of the boundary box surrounding the target object to completely envelop the target object. Based on this reference plane and boundary box, the processor 110 establishes a 3D coordinate system centered on the target object and defines the 3D shooting range. This 3D shooting range contains multiple pixel 3D coordinates, used for subsequent coverage density calculations.

When the image capturing device 100 captures a first image, the processor 110 records the spatial information at the time of capture. Specifically, the processor 110 identifies the capturing position (i.e., the first 3D coordinates of the image capturing device 100 in the 3D coordinate system) and shooting direction (i.e., first viewing angle) of each first image. This spatial information can be stored as metadata to correspond to the captured first images.

After obtaining the first image, the processor 110 calculates the coverage density data of the first image based on the coverage density distribution model. This calculation process includes: First, the processor 110 identifies the center pixel in the first image's pixels and finds all target pixels corresponding to the target object. Next, the processor 110 calculates the reference distance between each target pixel and the center pixel. Based on these reference distances, the processor 110 assigns first coverage density values to each target pixel using the coverage density distribution model.

Finally, the processor 110 maps these target pixels to corresponding pixel 3D coordinates in the 3D shooting range through the spatial relationship of the capturing position and first viewing angle, thereby establishing the correspondence between 2D images and 3D space. This mapping relationship enables the system to evaluate the coverage situation of the target object in 3D space, and further determine whether re-shooting is needed.

It should be noted that, in one embodiment, the coverage density distribution model will be dynamically adjusted according to the actual shooting conditions of the image capturing device 100. These conditions include: field of view parameters of the camera module 140 (such as viewing angle size, focal length, etc.), and the relative distance between the image capturing device 100 and the target object. Through dynamically adjusting model parameters, a more accurate evaluation of each pixel's coverage degree on the target object can be achieved. For example, in one embodiment, the coverage density distribution model is dynamically adjusted based on two factors:
(1) Field of View (FOV) of the camera module: When the FOV is larger (such as with a wide-angle lens), since a single shot can cover a larger range, the coverage density distribution curve correspondingly becomes wider; when the FOV is smaller (such as with a telephoto lens), since the single shot coverage range is smaller, the curve becomes narrower.
(2) Relative distance to the target object: When the distance is greater, a single viewing angle can cover a larger range, making the coverage density distribution curve wider and more gradual; when the distance is closer, the single viewing angle covers a smaller range, making the coverage density distribution curve narrower and steeper.

This mechanism of dynamically adjusting the coverage density distribution curve ensures accurate coverage density evaluation under different shooting conditions.

In step S220, determine one or more re-shooting positions based on the first coverage density data of each of the first images. Specifically, the processor 110 can project the pixel 3D coordinates of the 3D shooting range onto a 2D plane to generate a corresponding 2D mapping diagram. This 2D mapping diagram includes multiple pixel 2D coordinates corresponding to those pixel 3D coordinates. The processor 110 updates the 2D mapping diagram based on the first coverage density data of each first image, wherein each pixel 2D coordinate records the maximum first coverage density value of the corresponding pixel 3D coordinates. Next, based on the 2D mapping diagram, the processor 110 can identify one or more low density pixel 3D coordinates where first coverage density values are below a preset density threshold value, and determine one or more re-shooting positions based on these low density pixel 3D coordinates and corresponding viewing angles.

In step S230, render one or more shooting position suggestion marks corresponding to the one or more re-shooting positions in an image corresponding to real space displayed in real-time by the electronic device. Specifically, the processor 110 can use augmented reality technology to overlay shooting position suggestion marks onto the real scene image displayed in real-time by the display 150. Each shooting position suggestion mark can include suggested 3D coordinates corresponding to the 3D coordinate system and 3D shooting range, and a suggested second viewing angle corresponding to those suggested 3D coordinates.

In step S240, for a target shooting position suggestion mark among the one or more shooting position suggestion marks, in response to determining that the current position and current viewing angle of the electronic device match the target shooting position suggestion mark, automatically capture a target second image corresponding to the target shooting position suggestion mark toward the target object. Specifically, based on data from various sensors (such as IMU, depth camera, etc.), the processor 110 can determine whether the current 3D coordinates of the image capturing device 100 correspond to the suggested 3D coordinates and whether the current viewing angle corresponds to the suggested second viewing angle. If the conditions are met, then control the camera module 140 to automatically execute image capture operation.

In this embodiment, the above steps can be repeatedly executed until the coverage density values of all shooting positions reach the preset threshold value, or until the overall coverage density average value reaches the preset average density threshold value. This method ensures that sufficient image data is collected to support subsequent 3D object reconstruction operations.

Specifically, as in another embodiment, the method further includes: after capturing one or more second images corresponding to the one or more shooting position suggestion marks, obtaining second coverage density data of each of the one or more second images; obtaining a coverage density average value corresponding to the target object based on the first coverage density data of each of the first images and the second coverage density data of the one or more second images; and when the coverage density average value is greater than or equal to a preset average density threshold value, determining that image data for constructing the 3D object model has been collected completely, and using the captured one or more first images and the one or more second images to execute a 3D object reconstruction operation corresponding to the target object, so as to construct the 3D object model corresponding to the target object.

Wherein, when the coverage density average value is less than the preset average density threshold value, determining that the image data for constructing the 3D object model has not been collected completely; determining one or more other re-shooting positions based on the first coverage density data of the first images and the second coverage density data of the one or more second images; rendering one or more other shooting position suggestion marks corresponding to the one or more other re-shooting positions in the image corresponding to the real space displayed in real-time by the electronic device; and for a target other shooting position suggestion mark among the one or more other shooting position suggestion marks, in response to determining that the current position and the current viewing angle of the electronic device match the target other shooting position suggestion mark, automatically capturing a target third image corresponding to the target other shooting position suggestion mark toward the target object.

Simply put, in one embodiment, after the image capturing device 100 completes capturing the target second image, the processor 110 further executes coverage density evaluation and subsequent shooting control. Specifically, the processor 110 first obtains second coverage density data of each of the one or more second images, and combines with the previous first coverage density data of the first images to calculate the overall coverage density average value of the target object. If the coverage density average value reaches or exceeds the preset average density threshold value, the processor 110 determines that sufficient image data has been collected, and immediately uses all captured first images and second images to execute 3D object reconstruction operation to construct the 3D object model of the target object.

Conversely, if the coverage density average value is less than the preset average density threshold value, the processor 110 determines new re-shooting positions based on the existing first and second coverage density data, and render corresponding other shooting position suggestion marks in the image on the display 150. When the position and viewing angle of the image capturing device 100 match a target other shooting position suggestion mark, the processor 110 automatically controls the camera module 140 to capture the target third image to supplement the completeness of the image data. This process can be repeated until the expected coverage density requirements are met.

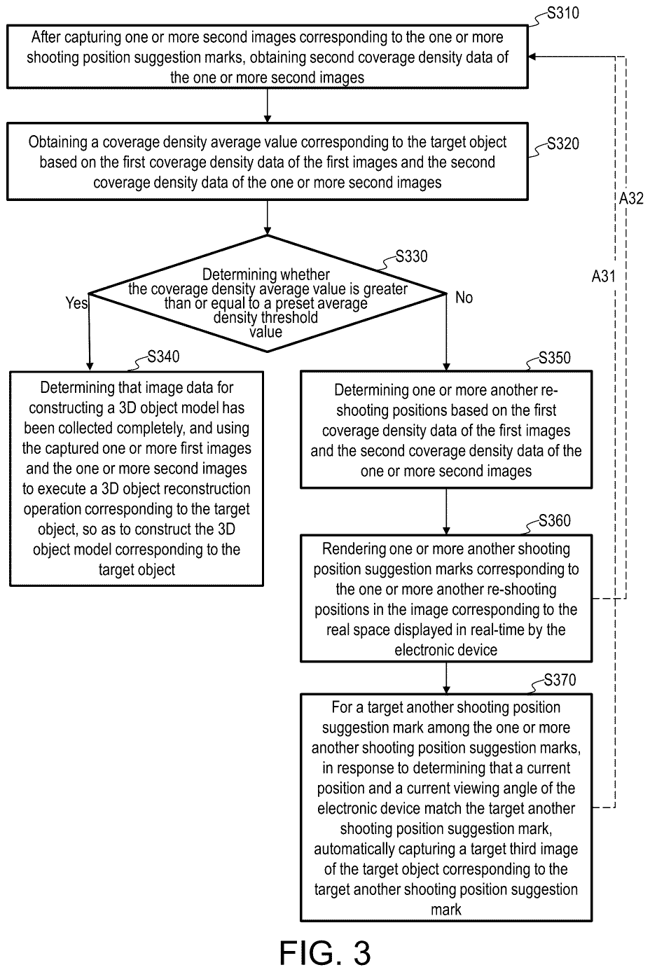

FIG. 3 is a flow chart of an image collection method according to another embodiment of the present disclosure.

In another embodiment, following the flow chart of FIG. 2, the image collection method of the present disclosure further includes steps S310 to S370.

In step S310, after the image capturing device 100 completes capturing one or more second images corresponding to the shooting position suggestion marks, the processor 110 obtains second coverage density data of each of the one or more second images. The calculation method for these second coverage density data is the same as the calculation method for the coverage density data of the previous first images, both based on the coverage density distribution model.

In step S320, the processor 110 combines the first coverage density data of the first images and the second coverage density data of the second images to calculate the overall coverage density average value of the target object. Specifically, the processor 110 considers the coverage degree of all captured images for various parts of the target object to comprehensively evaluate the overall coverage situation.

In step S330, the processor 110 determines whether the coverage density average value has reached or exceeded the preset average density threshold value. This threshold value can be set according to the user's requirements for 3D object model quality (these requirements can be set through related software/interface). If the determination result is “yes”, then proceed to step S340; if the determination result is “no”, then proceed to step S350. In one embodiment, the processor 110 uses Structural Similarity Index (SSIM) as an indicator for evaluating model quality. Higher SSIM values indicate higher structural similarity between the reconstructed model and the actual object. The processor 110 dynamically adjusts the preset average density threshold value based on the expected SSIM target value (the higher the SSIM, the higher the preset average density threshold value will be set). The processor 110 can receive input data (e.g., users can set the desired object quality through the 3D object modeling interface) to set the corresponding SSIM value, and thereby dynamically adjust the preset average density threshold value.

In step S340, the processor 110 determines that sufficient image data has been collected and can begin constructing the 3D object model. At this time, the processor 110 uses all captured first images and second images to execute 3D object reconstruction operation for the target object to generate the corresponding 3D object model.

If the coverage density average value does not meet the standard, then proceed to step S350.

In step S350, the processor 110 analyzes areas with insufficient coverage density on the target object based on the existing first and second coverage density data to determine one or more other re-shooting positions. These new shooting positions mainly focus on supplementing areas with lower coverage density.

In step S360, the processor 110 renders the other shooting position suggestion marks corresponding to these other re-shooting positions in the real space image displayed in real-time by the display 150. These new shooting suggestion marks are also presented using augmented reality technology to help users accurately position.

In step S370, when the current position and current viewing angle of the image capturing device 100 match a certain target other shooting position suggestion mark, the processor 110 controls the camera module 140 to automatically capture the corresponding target third image. After completing this capture, the processor 110 executes another iteration process, for example, shooting and obtaining new images (e.g., target third image) based on the new shooting position suggestion marks (e.g., target other shooting position suggestion mark) to enter step S310 and execute another round of iteration process (as indicated by arrow A31). The processor 110 recalculates coverage density and evaluate whether continued re-shooting is needed.

This iteration process will continue until the overall coverage density value (e.g., coverage density average value) is not less than the preset average density threshold value, ensuring that the final 3D object model has sufficient detail accuracy.

On the other hand, as indicated by arrow A32, without executing step S370 (for example, when users themselves use the image capturing device 100 for re-shooting), the captured images serve as new second images and continue to execute step S310 to start a new round of iteration process.

In one embodiment, when the processor 110 determines that image data collection is complete, it begins the executing 3D object reconstruction operation. This reconstruction operation can include the following steps: First, the processor 110 preprocesses all captured first images and second images. Specifically, the processor 110 can execute image correction, including eliminating lens distortion, adjusting exposure and white balance, to ensure image quality consistency. Next, the processor 110 executes feature point detection and matching. The processor 110 identifies feature points in each image (for example, SIFT, SURF, or ORB feature points) and establishes feature point correspondence relationships between different images. After obtaining feature point correspondence relationships, the processor 110 executes Structure from Motion (SfM) computation. Then, the processor 110 uses triangulation methods to restore feature points from two-dimensional images into point cloud data in three-dimensional space. After completing the above steps, the processor 110 stores the constructed 3D object model in the storage device 120. The 3D object model contains geometric mesh data and corresponding texture information, which can be used for subsequent display, editing, or other applications.

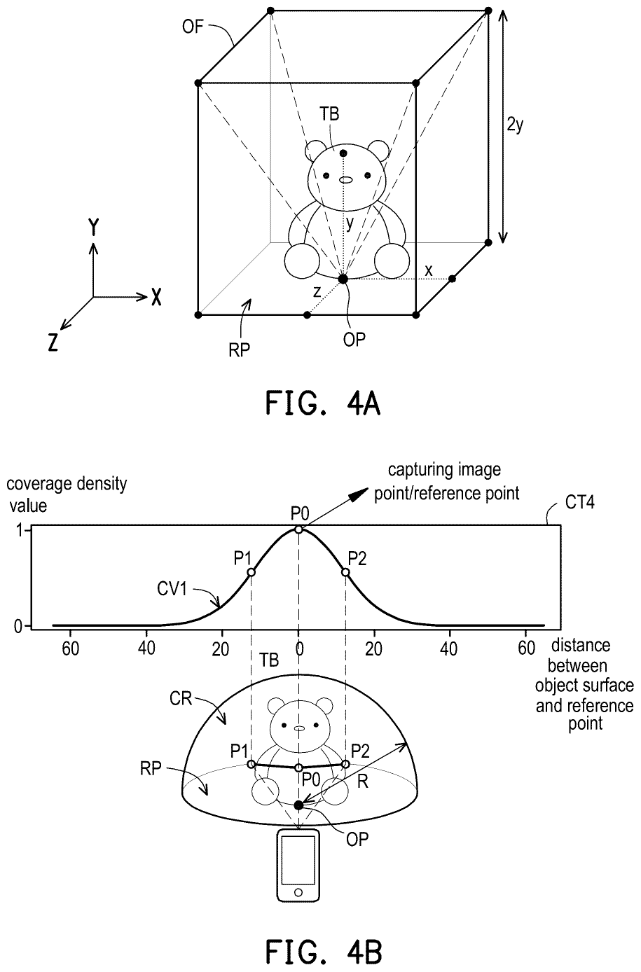

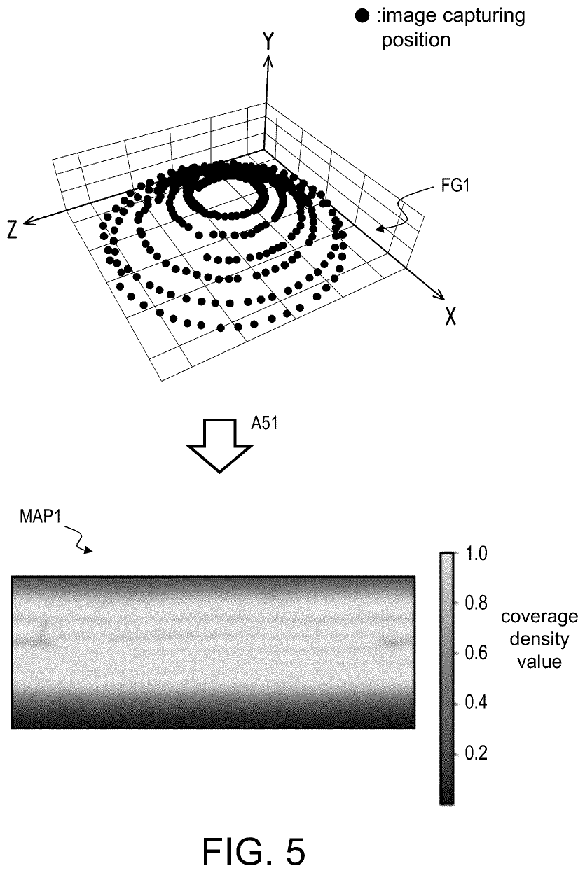

FIG. 4A is a schematic diagram showing the establishment of a 3D coordinate system and 3D shooting range corresponding to the target object in real space according to an embodiment of the present disclosure.

In one embodiment, as shown in FIG. 4A, the present disclosure first obtains images of the target object TB (e.g., a teddy bear) in real space through the camera module 140. Then, the processor 110 detects the reference plane RP (e.g., desktop, ground, or wall) where the target object TB is located, and establishes a 3D coordinate system centered on coordinate system origin point OP, where the X-axis and Z-axis are parallel to the reference plane RP, and the Y-axis is perpendicular to the reference plane RP. The coordinate system origin point OP can be preset as the center point of the reference plane corresponding to the target object.

After establishing the 3D coordinate system, in one embodiment, the position and size of the boundary box OF can be adaptively adjusted according to the size dimensions of the target object TB. Corresponding to the height y (or longer edge length) of the target object TB, the boundary box OF can be set as a cube with height 2y, used to completely envelop the target object TB. The processor 110 calculates the radius R of the 3D shooting range based on the dimensions of the boundary box OF. In another embodiment, the dimensions of the boundary box OF can be based on adding a predetermined length to the edge length corresponding to each coordinate axis.

Specifically, in one embodiment, the processor 110 first calculates the distance r from the center of the boundary box OF (i.e., coordinate system origin point OP) to the vertex of the boundary box OF. This distance r can be calculated using the following formula: r=√(x²+(2y)²+z²) where x, y, and z are the half-lengths of the boundary box OF in the X, Y, and Z axis directions respectively (in this example, x and z are both equal to y).

Next, the processor 110 uses r and a Sigmoid scaling function to calculate the actual radius R of the 3D shooting range: R=r*scale=r*[(upper−lower)/(1+exp(−k·(−r−d₀)))+lower].

Where: upper is the maximum value of scale (e.g., 3); lower is the minimum value of scale (e.g., 1); d₀ is the center point of the sigmoid function (e.g., 0.25); k is the steepness of the Sigmoid curve (e.g., 10). Through this method, the processor 110 can dynamically adjust the radius r of the 3D shooting range based on the actual size of the target object TB. When the boundary box OF is larger, the shooting range correspondingly increases, but the rate of increase gradually slows to avoid shooting distance being too far; when the boundary box OF is smaller, the shooting range correspondingly decreases, but still maintains sufficient minimum distance to ensure complete capture of images of the target object TB.

This method of dynamically adjusting the shooting range based on the size of the boundary box OF ensures that when subsequently providing suggested shooting positions, the suggested shooting positions will neither be too close (leading to inability to completely capture the target object TB) nor too far (leading to insufficient image detail), thereby improving the efficiency and quality of image collection.

FIG. 4B is a schematic diagram showing a distribution curve of coverage density values corresponding to capturing image points according to an embodiment of the present disclosure.

In one embodiment, referring to FIG. 4B, the upper half of FIG. 4B shows the coverage density distribution curve CV1 in graph CT4, and the lower half shows the corresponding spatial diagram, which displays the target object TB located on the reference plane RP and surrounded by the 3D shooting range CR (with radius R).

When the image capturing device 100 captures images, the processor 110 first identifies center pixels (i.e., the capturing image point P0 shown in the figure). Then, the processor 110 identifies target pixels corresponding to the target object TB, such as the pixel points P1 and P2 shown in the figure located at both ends of the target object TB.

To calculate the coverage density value for each target pixel, the processor 110 needs to obtain the reference distance between each target pixel and center pixel P0. For example, in one embodiment, these distances can be calculated using the Haversine formula, which considers the actual distance between two points on a sphere. In another embodiment, these distances can be calculated using one of the following methods:
(1) Euclidean Distance Calculation Method: Convert pixel positions in the image to 2D plane coordinates; use the formula d=√((x₁−x₀)²+(y₁−y₀)²) to calculate the distance between two points.
(2) Depth Information Integration Method: Use depth camera or stereo vision to obtain depth values for each pixel; combine pixel 2D positions and depth values to establish 3D space coordinates; calculate actual distances in 3D space.
(3) Camera Parameter Conversion Method: Use camera internal parameters (focal length, principal point, etc.); convert pixel coordinates to camera coordinate system; calculate spatial distances in the camera coordinate system.
(4) Angular Distance Method: Calculate the viewing angle of target pixels relative to the center pixel; convert to actual distance by combining known shooting distance; suitable for processing spherical or cylindrical objects.

In this embodiment, the reference distance is represented as the distance between the object surface and the reference point, and its unit can be pixels or actual distance units.

The coverage density distribution curve CV1 exhibits a shape similar to a Gaussian distribution (with the original Gaussian distribution peak value proportionally scaled to 1). Centered on the capturing image point P0 (also called the reference point, corresponding to the center pixel), the coverage density distribution curve CV1 shows the coverage density values corresponding to different distances. When target pixels are near the center pixel P0 (distance close to 0), their coverage density values are close to 1; as the distance from center pixel P0 increases, the coverage density value gradually decreases, eventually approaching 0 at greater distances (such as ±60 distance units). In this example, the coverage density value of center pixel P0 is set to 1. Note that the distance unit numbers in the figure are for illustrative purposes only.

Specifically, in this embodiment, the shape of the coverage density distribution curve CV1 can be preset as a fixed pattern. However, the present invention is not limited to this.

For example, in another embodiment, the shape of the coverage density distribution curve CV1 can be dynamically adjusted. More specifically, the processor 110 dynamically adjusts the parameters of the coverage density distribution model based on the image capturing device 100's shooting field of view parameters (such as viewing angle size, focal length, etc.) and the relative distance between the image capturing device 100 and the target object TB. This adjustment ensures: (1) when the image capturing device 100 is closer to the target object TB, the coverage density distribution curve is narrower and steeper, indicating each pixel corresponds to a smaller spatial range; (2) when the image capturing device 100 is farther from the target object TB, the coverage density distribution curve is wider and more gentle, indicating each pixel corresponds to a larger spatial range.

Through this method, the processor 110 can calculate the coverage density value for each target pixel in the image, and thereby evaluate the coverage degree of the entire image for the target object TB. These coverage density values will subsequently be used to determine whether re-shooting is needed and the suggested re-shooting positions.

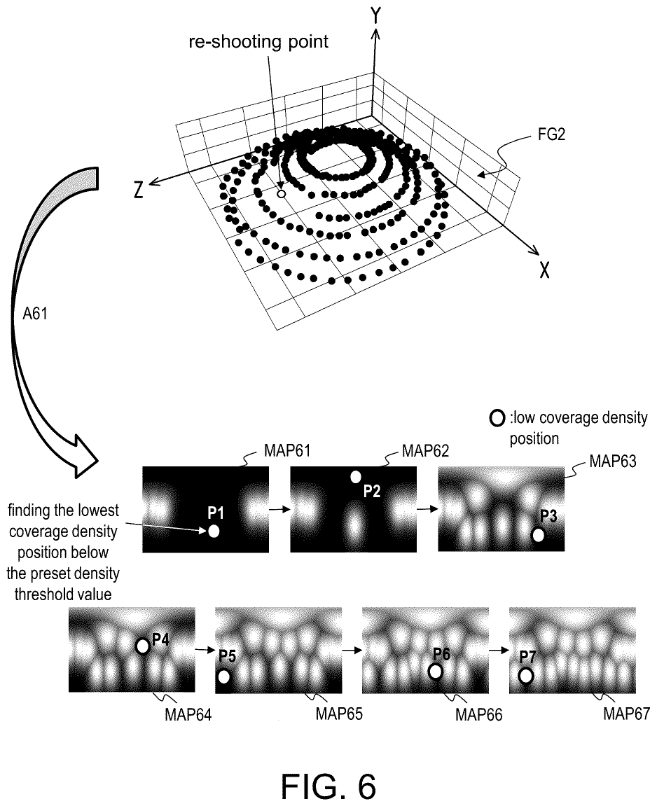

FIG. 5 is a schematic diagram showing the generation of a corresponding 2D mapping diagram based on multiple captured images according to an embodiment of the present disclosure. FIG. 5 demonstrates how the present disclosure converts coverage density information in 3D space into a 2D mapping diagram. As shown in the figure, FIG. 5 contains a schematic diagram FG1 of multiple image capturing positions in the 3D shooting range and its corresponding 2D mapping diagram MAP1, connected through the projection transformation step A51.

In the 3D space distribution diagram FG1, each blue dot represents an image capturing position, these positions show a spiral distribution, indicating the trajectory of the image capturing device 100 performing multi-angle shooting around the target object. Each capturing position corresponds to a set of coverage density data, which reflects the coverage degree of images captured at that position for the target object.

The processor 110 adopts UV Mapping technology to project pixel 3D coordinates within the 3D shooting range onto a 2D plane. This process is similar to the principle of unfolding the Earth's surface (3D sphere) into a world map (2D plane). Specifically, the processor 110 maps points p(x,y,z) in 3D space to points p(u,v) on the 2D plane, where u and v represent horizontal and vertical coordinates on the 2D mapping diagram respectively.

In the 2D mapping diagram MAP1, grayness represent the magnitude of coverage density values, ranging from darker gray (approximately 0.2) to lighter gray (approximately 0.8). The coverage density values and 3D pixels corresponding to each image capturing position's center pixel and multiple target pixels can be mapped to the 2D mapping diagram MAP1. Only the maximum coverage density value is retained for identical coordinates.

In other words, each pixel 2D coordinate in the 2D mapping diagram MAP1 corresponds to a position in the original 3D space, with its color reflecting the coverage density value of that position. When multiple images' coverage areas overlap, the processor 110 retains the maximum coverage density value as the final value for that pixel.

For example, if three images have coverage density values of 0.3, 0.6, and 0.4 respectively for a certain 3D pixel coordinate, then that 3D pixel coordinate's 2D pixel coordinate in the 2D mapping diagram MAP1 records a coverage density value of 0.6 (corresponding to a lighter green color). This method ensures the 2D mapping diagram can accurately reflect the degree to which each area has been optimally captured.

Through this mapping method, the processor 110 can: intuitively present the shooting coverage situation of various parts of the target object, quickly identify areas with lower coverage density (darker colored parts), evaluate the completeness of overall shooting; and thereby provide a basis for subsequent re-shooting position decisions.

Furthermore, the benefits of the 2D mapping diagram include: reducing data processing complexity (no need to process 3D coordinate system); providing a unified evaluation plane; facilitating visualization presentation; simplifying the calculation process of re-shooting positions. It should be noted that in one embodiment, various operations applied to the 2D mapping diagram can be accelerated through hardware (such as image processors). For example, parallel merging computation of multiple coverage density data, simultaneous updating of numerous pixel points, real-time comparison and updating of maximum coverage density values, determination/calculation of re-shooting positions, priority ordering of re-shooting positions, and so on.

In practical applications, the processor 110 continuously updates the 2D mapping diagram MAP1, updating corresponding area values based on new coverage density data whenever new images are captured, thereby reflecting shooting progress in real-time.

In one embodiment, determining the one or more re-shooting positions based on the first coverage density data of each of the one or more first images (step S220) includes: obtaining a coverage density average value corresponding to the target object based on the first coverage density data of each of the first images; when the coverage density average value is less than a preset average density threshold value, identifying one or more low density pixel 3D coordinates with first coverage density values below a preset density threshold value based on the 2D mapping diagram; and determining the one or more re-shooting positions based on the one or more low density pixel 3D coordinates and corresponding one or more viewing angles.

In one embodiment, after obtaining first coverage density data of one or more first images, the processor 110 executes the following steps to determine re-shooting positions:

First, the processor 110 calculates the overall coverage density average value based on the first coverage density data of each first image. This coverage density average value represents the overall coverage degree of currently captured images for the target object TB. When the coverage density average value is below the preset average density threshold value (for example, 0.6), it indicates that more supplementary images need to be captured.

Next, the processor 110 analyzes the 2D mapping diagram to find areas with lower coverage density values. Specifically, the processor 110 identifies pixel 2D coordinates in the 2D mapping diagram where first coverage density values from the first images are below the preset density threshold value. Then, the processor 110 converts these low-density pixel 2D coordinates back to corresponding pixel 3D coordinates, which represent positions on the target object TB's surface that need re-shooting.

Finally, the processor 110 determines new shooting positions based on these low density pixel 3D coordinates, considering the constraints of the 3D shooting range CR. These re-shooting positions will be paired with appropriate shooting angles to ensure effective improvement of coverage density values in low-density areas. Each re-shooting position is within the 3D shooting range CR with radius R, and needs to consider the constraints of the reference plane RP. That is, the suggested re-shooting positions all consider the position of the actual reference plane RP and do not suggest shooting positions that are practically impossible to achieve. For example, if the reference plane RP corresponds to a desktop where the target object is placed above, re-shooting positions will not be below that desktop.

In the above embodiment, determining the one or more re-shooting positions based on the one or more low density pixel 3D coordinates and corresponding one or more viewing angles includes: identifying a target low density pixel 3D coordinate having a lowest first coverage density value among the one or more low density pixel 3D coordinates; determining a corresponding target re-shooting position based on the target low density pixel 3D coordinate; estimating an expected first image corresponding to the target re-shooting position and expected first coverage density data corresponding to the expected first image; updating the 2D mapping diagram based on the expected first coverage density data, and re-identifying new one or more low density pixel 3D coordinates with first coverage density values below the preset density threshold value; and repeating the above steps until no low density pixel 3D coordinates with values below the preset density threshold value exist among the pixel 3D coordinates.

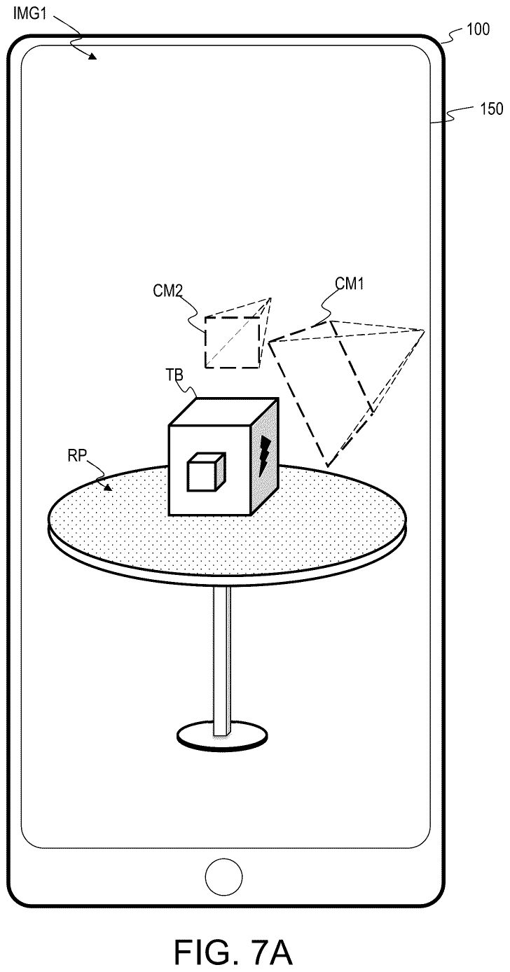

The following uses FIG. 6 to explain further details of determining the one or more re-shooting positions based on the one or more low density pixel 3D coordinates and corresponding one or more viewing angles.

FIG. 6 is a schematic diagram showing the determination of one or more re-shooting positions based on the 2D mapping diagram according to an embodiment of the present disclosure.

In one embodiment, in the upper half of FIG. 6 showing the 3D space distribution diagram FG2, each black dot represents an image capturing position. Each image capturing position corresponds to a set of coverage density data, which reflects the coverage degree of images captured at that position for the target object. The lower half of FIG. 6 shows a series of 2D mapping diagrams MAP61 to MAP67, used to illustrate the iteration process of determining these re-shooting positions.

In this embodiment, through multiple sets of coverage density data from multiple image capturing positions in the 3D space distribution diagram FG2, the first re-shooting point (suggested re-shooting position) corresponding to the lowest coverage density value can be obtained. As indicated by arrow A61, from this first re-shooting point, the processor 110 can deduce subsequent multiple re-shooting points.

More specifically, the processor 110 first identifies in 2D mapping diagram MAP61 the target low density pixel 2D coordinate P1 (also called the target low density pixel position) having the lowest first coverage density value. In the 2D mapping diagram, brighter areas represent higher coverage density values, while darker areas represent lower coverage density values. The processor 110 converts this target low density pixel 2D coordinate P1 from the 2D mapping diagram back to the target low density pixel 3D coordinate in the 3D coordinate system, and based on this determines the corresponding target re-shooting position.

This iteration process continues, sequentially identifying re-shooting positions P3 (as shown in MAP63), P4 (as shown in MAP64), P5 (as shown in MAP65), P6 (as shown in MAP66), and P7 (as shown in MAP67). After each new re-shooting position is identified, the processor 110 deduces the potential improvement in coverage density values and correspondingly update the 2D mapping diagram, reflecting the expected coverage density improvement situation.

This iteration process will continue until the overall coverage density value (e.g., coverage density average value) of the 2D mapping diagram is not less than the preset average density threshold value. Through this method, the processor 110 can systematically plan out a series of re-shooting positions (also called re-shooting positions) after obtaining a batch of first images, ensuring complete coverage of all parts of the target object, thereby improving the efficiency of re-shooting position suggestions (no need to wait for one supplementary shot before suggesting a new re-shooting position).

In one embodiment, the image capturing device 100 uses augmented reality (AR) technology to render one or more shooting position suggestion marks corresponding to the one or more re-shooting positions in the image corresponding to the real space displayed in real-time by the image capturing device 100 (also called electronic device), such that the one or more shooting position suggestion marks are visually embedded and fixed in the real space in the corresponding image.

More specifically, in one embodiment, the processor 110 uses augmented reality (AR) technology to embed the shooting position suggestion marks CM in the real space image displayed by the display 150. Specifically, the processor 110 can integrate data from the camera module 140 and other sensors (such as Inertial Measurement Unit (IMU), depth camera, etc.) to establish a 3D reference coordinate system for the real space.

When the camera module 140 captures the real space image, the processor 110 tracks the position and pose changes of the image capturing device 100 in real-time. Through the accelerometer and gyroscope data from the IMU, the processor 110 can determine the movement trajectory and rotation angles of the image capturing device 100. Meanwhile, through depth information provided by the depth camera or stereo vision camera (e.g., multi-lens camera), the processor 110 can accurately determine the relative distances between the image capturing device 100 and various objects in the real space.

Based on this spatial positioning information, the processor 110 converts the calculated re-shooting positions into specific positions in the real space coordinate system. Then, the processor 110 renders shooting position suggestion marks CM at these positions. Since a reference system for the real space has been established, these shooting position suggestion marks CM remains fixed at specific positions in space like real objects, not changing position with the movement of the image capturing device 100.

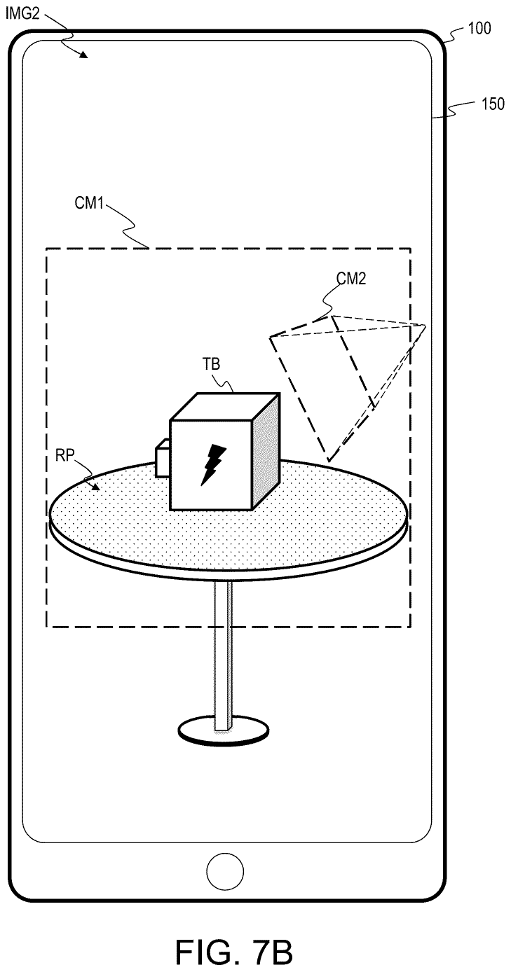

When users view the real space through the display 150, these shooting position suggestion marks CM naturally blend into the image as if they truly exist in the space. For example, when users hold the image capturing device 100 and move around the target object, the shooting position suggestion marks CM undergo appropriate visual changes with the change in viewing angle, including size scaling, angle rotation, etc., while maintaining their original designated spatial positions. This visual effect helps users intuitively understand and move to the suggested shooting positions. The following uses FIGS. 7A and 7B to further describe this concept.

FIGS. 7A and 7B are schematic diagrams showing shooting position suggestion marks corresponding to re-shooting positions rendered in real-time displayed images corresponding to real space according to an embodiment of the present disclosure.

In one embodiment, FIG. 7A and FIG. 7B demonstrate how the display 150 of the image capturing device 100 uses augmented reality (AR) technology to display shooting position suggestion marks. In this example, the target object TB is placed on the reference plane RP (circular desktop), and the processor 110 renders shooting position suggestion marks CM1 and CM2 in the real-time image(scene) of the display 150 based on previously calculated re-shooting positions.

As shown in FIG. 7A, in the image IMG1 displayed by the display 150, shooting position suggestion mark CM1 is located at a relatively far position on the right side of the target object TB (with a lightning icon), while shooting position suggestion mark CM2 is located at a relatively far position behind the target object TB. Each shooting position suggestion mark is presented in the form of a dashed frame, with its size and direction indicating the suggested shooting position and angle. The shape of the shooting position suggestion mark is similar to a quadrangular pyramid, with its vertex corresponding to the viewpoint source, set according to the shooting direction suggested by the re-shooting position.

When the image capturing device 100 moves to the position of shooting position suggestion mark CM1, as shown in image IMG2 in FIG. 7B, since shooting position suggestion mark CM1 is embedded in the image/interface displayed by the display 150, when the image capturing device 100 reaches the position of shooting position suggestion mark CM1 (moved to the right side of the target object TB in FIG. 7A, facing the lightning icon), the screen only shows the planar dashed frame of shooting position suggestion mark CM1 (imagine the image capturing device 100 has entered the pyramidal portion of shooting position suggestion mark CM1, looking towards the plane of shooting position suggestion mark CM1). Meanwhile, shooting position suggestion mark CM2 maintains its original three-dimensional shape, but its position will be to the right of shooting position suggestion mark CM1 in image IMG2 of FIG. 7B, indicating the next suggested shooting position.

These shooting position suggestion marks appear fixed in real space in the display 150's image and do not change their position in this space with the movement of the image capturing device 100, which helps users precisely move to the suggested shooting positions. However, the shape and size of shooting position suggestion marks CM1 and CM2 change correspondingly with the relative position between the image capturing device 100 and them (for example, the closer the distance between the image capturing device 100 and the shooting position suggestion marks, the larger the shooting position suggestion marks appear in the image capturing device 100's screen). When the position and viewing angle of the image capturing device 100 match a certain shooting position suggestion mark, the processor 110 automatically triggers the camera module 140 to perform image capture.

In another embodiment, the processor 110 directly processes coverage density-related calculations in the 3D coordinate system. Specifically, the processor 110 establishes corresponding data structures for each pixel 3D coordinate to store the coverage density information of that coordinate position.

First, the processor 110 directly records the first coverage density values from each first image's coverage density data to corresponding pixel 3D coordinates. For example, when a target pixel in a first image corresponds to a certain pixel 3D coordinate in 3D space, the processor 110 stores that target pixel's first coverage density value in the data structure of that pixel 3D coordinate. If that pixel 3D coordinate already has coverage density values from other first images, the processor 110 retains the maximum coverage density value.

Next, the processor 110 scans all pixel 3D coordinates in the 3D coordinate system. For each pixel 3D coordinate, the processor 110 compares whether its recorded first coverage density value is below the preset density threshold value. If below this threshold value, the processor 110 marks that pixel 3D coordinate as a low density pixel 3D coordinate. After complete scanning, the processor 110 obtains a set of low density pixel 3D coordinates that need re-shooting.

Finally, the processor 110 determines appropriate re-shooting positions within the 3D shooting range based on the spatial distribution of these low density pixel 3D coordinates and their respective required shooting angles. This method of performing calculations directly in 3D space can record the coverage situation of the target object in space without requiring coordinate conversion, and thereby can determine positions that need re-shooting.

Based on the above, the image collection method and image capturing device provided by the present disclosure determine the coverage degree of captured images for the target object through coverage density data calculation and corresponding evaluation mechanisms, and dynamically determine re-shooting positions. The present disclosure uses augmented reality technology to render shooting position suggestion marks in the image displayed in real-time by the electronic device (also called 3D object modeling interface), facilitating guidance of the image capturing device to appropriate shooting positions. The present disclosure further provides automatic image capture functionality, determining whether the current position and angle match the shooting position suggestion mark when the image capturing device moves to the designated position, and if matched, automatically capturing the image. The present disclosure ensures the completeness of image collection through setting of coverage density average values and density threshold values, and provides shooting suggestions that conform to actual environmental conditions while considering the placement environment of the target object.

It will be apparent to those skilled in the art that various modifications and variations can be made to the disclosed embodiments without departing from the scope or spirit of the disclosure. In view of the foregoing, it is intended that the disclosure covers modifications and variations provided that they fall within the scope of the following claims and their equivalents.

What is claimed is:

1. An image collection method, adapted for constructing a 3D object model corresponding a target object by an electronic device, comprising:
based on captured one or more first images of the target object, obtaining first coverage density data of each of the one or more first images;
determining one or more re-shooting positions based on the first coverage density data of each of the one or more first images;
rendering one or more shooting position suggestion marks corresponding to the one or more re-shooting positions in an image corresponding to a real space displayed in real-time by the electronic device;
for a target shooting position suggestion mark among the one or more shooting position suggestion marks, in response to determining that a current position and a current viewing angle of the electronic device match the target shooting position suggestion mark, automatically capturing a target second image corresponding to the target shooting position suggestion mark toward the target object.

2. The image collection method according to claim 1, further comprising:
after capturing one or more second images corresponding to the one or more shooting position suggestion marks, obtaining second coverage density data of each of the one or more second images;
obtaining a coverage density average value corresponding to the target object based on the first coverage density data of the first images and the second coverage density data of the one or more second images; and
when the coverage density average value is greater than or equal to a preset average density threshold value, determining image data for constructing the 3D object model has been collected completely, and using captured the one or more first images and the one or more second images to execute a 3D object reconstruction operation corresponding to the target object, so as to construct the 3D object model corresponding to the target object.

3. The image collection method according to claim 2, further comprising:
when the coverage density average value is less than the preset average density threshold value, determining that the image data for constructing the 3D object model has not been collected completely;
determining one or more other re-shooting positions based on the first coverage density data of the first images and the second coverage density data of the one or more second images;
rendering one or more other shooting position suggestion marks corresponding to the one or more other re-shooting positions in the image corresponding to the real space displayed in real-time by the electronic device; and
for a target other shooting position suggestion mark among the one or more other shooting position suggestion marks, in response to determining that the current position and the current viewing angle of the electronic device match the target other shooting position suggestion mark, automatically capturing a target third image corresponding to the target other shooting position suggestion mark toward the target object.

4. The image collection method according to claim 1, before capturing the first image or the second image, further comprising:
obtaining a reference plane and a boundary box of the target object to establish a 3D coordinate system and a 3D shooting range corresponding to the target object in the real space.

5. The image collection method according to claim 4, wherein each shooting position suggestion mark comprises suggested 3D coordinates corresponding to the 3D coordinate system and the 3D shooting region and a suggested second viewing angle corresponding to the suggested 3D coordinates, the method further comprising:
determining whether current 3D coordinates of the current position of the electronic device correspond to a target suggested 3D coordinate among the one or more suggested 3D coordinates, and determining whether the current viewing angle of the electronic device corresponds to a target suggested second viewing angle of the target suggested 3D coordinate;
when the current 3D coordinates correspond to the target suggested 3D coordinate and the current viewing angle corresponds to the target suggested second viewing angle, determining that the current position and the current viewing angle of the electronic device match the corresponding target shooting position suggestion mark, and automatically executing an image capture operation toward the target object to capture the target second image corresponding to the target shooting position suggestion mark.

6. The image collection method according to claim 4, wherein the 3D shooting region comprises a plurality of pixel 3D coordinates, the method further comprising:
identifying a capturing position and a first viewing angle of each first image, wherein the capturing position comprises first 3D coordinates in the 3D coordinate system where the electronic device is located when capturing each first image; and
obtaining the first coverage density data corresponding to the target object of each first image based on a coverage density distribution model, wherein the first coverage density data comprises a plurality of first coverage density values of a plurality of first pixels corresponding to the first image and a plurality of first pixel 3D coordinates of the first pixels mapped to the pixel 3D coordinates, wherein the first pixel 3D coordinates are determined by the capturing position and the first viewing angle corresponding to the first image.

7. The image collection method according to claim 6, wherein obtaining the first coverage density data corresponding to the target object of each first image based on the coverage density distribution model comprises:
identifying a center pixel among the first pixels of each first image;
identifying a plurality of target pixels corresponding to the target object among the first pixels of each first image;
obtaining a reference distance between each target pixel and the center pixel;
looking up a first coverage density value of each target pixel based on the reference distance of each target pixel and the coverage density distribution model, wherein the coverage density distribution model is dynamically set according to shooting field of view parameters of the electronic device and a relative distance between the capturing position and the target object.

8. The image collection method according to claim 6, further comprising:
projecting the pixel 3D coordinates of the 3D shooting region onto a 2D plane to generate a corresponding 2D mapping diagram, wherein the 2D mapping diagram comprises a plurality of pixel 2D coordinates corresponding to the pixel 3D coordinates;
updating the 2D mapping diagram based on the first coverage density data corresponding to the target object of each first image, wherein each pixel 2D coordinate records a maximum first coverage density value of the corresponding pixel 3D coordinates.

9. The image collection method according to claim 8, wherein determining the one or more re-shooting positions based on the first coverage density data of the one or more first images comprises:
obtaining a coverage density average value corresponding to the target object based on the first coverage density data of each of the first images;
when the coverage density average value is less than a preset average density threshold value, identifying one or more low density pixel 3D coordinates with first coverage density values below a preset density threshold value based on the 2D mapping diagram; and
determining the one or more re-shooting positions based on the one or more low density pixel 3D coordinates and corresponding one or more viewing angles.

10. The image collection method according to claim 9, wherein determining the one or more re-shooting positions based on the one or more low density pixel 3D coordinates and the corresponding one or more viewing angles comprises:
identifying a target low density pixel 3D coordinate having a lowest first coverage density value among the one or more low density pixel 3D coordinates;
determining a corresponding target re-shooting position based on the target low density pixel 3D coordinate;
estimating an expected first image corresponding to the target re-shooting position and expected first coverage density data corresponding to the expected first image;
updating the 2D mapping diagram based on the expected first coverage density data, and re-identifying new one or more low density pixel 3D coordinates with first coverage density values below the preset density threshold value; and
repeating the above steps until no low density pixel 3D coordinates with values below the preset density threshold value exist among the pixel 3D coordinates.

11. The image collection method according to claim 6, further comprising:
recording the plurality of first coverage density values in each first coverage density data at corresponding pixel 3D coordinates;
identifying one or more low density pixel 3D coordinates with first coverage density values below a preset density threshold value based on the first coverage density values recorded at each pixel 3D coordinate; and
determining the one or more re-shooting positions based on the one or more low density pixel 3D coordinates and corresponding one or more viewing angles.

12. The image collection method according to claim 1, further comprising:
using augmented reality (AR) technology to render the one or more shooting position suggestion marks corresponding to the one or more re-shooting positions in the image corresponding to the real space displayed in real-time by the electronic device, such that the one or more shooting position suggestion marks are visually embedded and fixed in the real space in the image.

13. An image capturing device for constructing a 3D object model corresponding to a target object, comprising:
a processor;
a storage device coupled to the processor for storing a plurality of program code modules;
a camera module coupled to the processor; and
a display coupled to the processor,
wherein the processor is configured through execution of the stored program code modules to:
obtain first coverage density data of one or more first images based on captured first images of the target object;
determine one or more re-shooting positions based on the first coverage density data of the one or more first images;
render one or more shooting position suggestion marks corresponding to the one or more re-shooting positions in an image corresponding to a real space displayed in real-time by the display;
for a target shooting position suggestion mark among the one or more shooting position suggestion marks, in response to determining that a current position and a current viewing angle of the image capturing device match the target shooting position suggestion mark, control the camera module to automatically capture a target second image corresponding to the target shooting position suggestion mark toward the target object.

14. The image capturing device according to claim 13, wherein the processor is further configured through execution of the program code modules stored in the storage device to:
after capturing one or more second images corresponding to the one or more shooting position suggestion marks, obtain second coverage density data of the one or more second images;
obtain a coverage density average value corresponding to the target object based on the first coverage density data of each first image and the second coverage density data of each second image; and
when the coverage density average value is greater than or equal to a preset average density threshold value, determine that image data for constructing the 3D object model has been collected completely, and use the captured one or more first images and the one or more second images to execute a 3D object reconstruction operation corresponding to the target object, so as to construct the 3D object model corresponding to the target object.

15. The image capturing device according to claim 14, wherein the processor is further configured to:
when the coverage density average value is less than the preset average density threshold value, determine that the image data for constructing the 3D object model has not been collected completely;
determine one or more other re-shooting positions based on the first coverage density data of each first image and the second coverage density data of each second image;
render one or more other shooting position suggestion marks corresponding to the one or more other re-shooting positions in the image corresponding to the real space displayed in real-time by the display; and
for a target other shooting position suggestion mark among the one or more other shooting position suggestion marks, in response to determining that the current position and the current viewing angle of the image capturing device match the target other shooting position suggestion mark, control the camera module to automatically capture a target third image corresponding to the target other shooting position suggestion mark toward the target object.

16. The image capturing device according to claim 13, wherein the processor is further configured to:
before capturing the first image or the second image, obtain a reference plane and a boundary box of the target object to establish a 3D coordinate system and a 3D shooting region corresponding to the target object in the real space.

17. The image capturing device according to claim 16, wherein each shooting position suggestion mark comprises suggested 3D coordinates corresponding to the 3D coordinate system and the 3D shooting region and a suggested second viewing angle corresponding to the suggested 3D coordinates, wherein the processor is further configured to:
determine whether current 3D coordinates of the current position of the image capturing device correspond to a target suggested 3D coordinate among the one or more suggested 3D coordinates, and determine whether the current viewing angle of the image capturing device corresponds to a target suggested second viewing angle of the target suggested 3D coordinate;
when the current 3D coordinates correspond to the target suggested 3D coordinate and the current viewing angle corresponds to the target suggested second viewing angle, determine that the current position and the current viewing angle of the image capturing device match the corresponding target shooting position suggestion mark, and control the camera module to automatically execute an image capture operation toward the target object to capture the target second image corresponding to the target shooting position suggestion mark.

18. The image capturing device according to claim 16, wherein the 3D shooting region comprises a plurality of pixel 3D coordinates, wherein the processor is further configured to:
identify a capturing position and a first viewing angle of each first image, wherein the capturing position comprises first 3D coordinates in the 3D coordinate system where the image capturing device is located when capturing each first image; and
obtain the first coverage density data corresponding to the target object of each first image based on a coverage density distribution model, wherein the first coverage density data comprises a plurality of first coverage density values of a plurality of first pixels corresponding to the first image and a plurality of first pixel 3D coordinates of the first pixels mapped to the pixel 3D coordinates, wherein the first pixel 3D coordinates are determined by the capturing position and the first viewing angle corresponding to the first image.

19. The image capturing device according to claim 18, wherein obtaining the first coverage density data corresponding to the target object of each first image based on the coverage density distribution model comprises:
identifying a center pixel among the first pixels of each first image;
identifying multiple target pixels corresponding to the target object among the first pixels of each first image;
obtaining a reference distance between each target pixel and the center pixel;
looking up a first coverage density value of each target pixel based on the reference distance of each target pixel and the coverage density distribution model, wherein the coverage density distribution model is dynamically set according to shooting field of view parameters of the image capturing device and a relative distance between the capturing position and the target object.

20. The image capturing device according to claim 18, wherein the processor is further configured to:
project the pixel 3D coordinates of the 3D shooting region onto a 2D plane to generate a corresponding 2D mapping diagram, wherein the 2D mapping diagram comprises a plurality of pixel 2D coordinates corresponding to the pixel 3D coordinates;
update the 2D mapping diagram based on the first coverage density data corresponding to the target object of each first image, wherein each pixel 2D coordinate records a maximum first coverage density value of the corresponding pixel 3D coordinates.

21. The image capturing device according to claim 20, wherein determining the one or more re-shooting positions based on the first coverage density data of the one or more first images comprises:
obtaining a coverage density average value corresponding to the target object based on the first coverage density data of each first image; and
when the coverage density average value is less than a preset average density threshold value, identifying one or more low density pixel 3D coordinates with first coverage density values below a preset density threshold value based on the 2D mapping diagram; and
determining the one or more re-shooting positions based on the one or more low density pixel 3D coordinates and corresponding one or more viewing angles.

22. The image capturing device according to claim 21, wherein determining the one or more re-shooting positions based on the one or more low density pixel 3D coordinates and the corresponding one or more viewing angles comprises:
identifying a target low density pixel 3D coordinate having a lowest first coverage density value among the one or more low density pixel 3D coordinates;
determining a corresponding target re-shooting position based on the target low density pixel 3D coordinate;
estimating an expected first image corresponding to the target re-shooting position and expected first coverage density data corresponding to the expected first image;
updating the 2D mapping diagram based on the expected first coverage density data, and re-identifying new one or more low density pixel 3D coordinates with first coverage density values below the preset density threshold value; and
repeating the above steps until no low density pixel 3D coordinates with values below the preset density threshold value exist among the pixel 3D coordinates.

23. The image capturing device according to claim 18, wherein the processor is further configured to:
record the plurality of first coverage density values in each first coverage density data at corresponding pixel 3D coordinates;
identify one or more low density pixel 3D coordinates with first coverage density values below a preset density threshold value based on the first coverage density values recorded at each pixel 3D coordinate; and
determine the one or more re-shooting positions based on the one or more low density pixel 3D coordinates and corresponding one or more viewing angles.

24. The image capturing device according to claim 13, wherein the processor is further configured to:
use augmented reality (AR) technology to render the one or more shooting position suggestion marks corresponding to the one or more re-shooting positions in the image corresponding to the real space displayed in real-time by the display, such that the one or more shooting position suggestion marks are visually embedded and fixed in the real space in the image.
